(19) United States
(12) Patent Application Publication
(10) Pub. No.: US 2012/0187169 A1
(43) Pub. Date: Jul. 26, 2012

(54) ACCESSORY HOLDER FOR HANDLEBARS

(75) Inventors: Darrel Wayne Osten, Coos Bay, OR (US); Lisa Jayne Reid, Portland, OR (US)

(73) Assignee: W.C.C., INC., Coos Bay, OR (US)

(21) Appl. No.: 13/296,176

(22) Filed: Nov. 14, 2011

Related U.S. Application Data
(63) Continuation-in-part of application No. 12/348,602, filed on Jan. 5, 2009, now abandoned.

(51) Int. Cl. B62J 11/00; B23P 11/00

(52) U.S. Cl. 224/414; 224/420; 29/428

(57) ABSTRACT

An accessory-holding assembly is provided for holding portable accessories on a set of handlebars. The assembly includes an elongate member sized to receive two or more general-purpose clips often associated with portable accessories. The elongate member may be part of an accessory holder that can be removed, with the accessories still attached, from the handlebars. This allows a rider to remove a plurality of portable accessories from the handlebars in a single action so that the rider can carry the entire accessory holder, including the accessories, into an area where bicycles are not permitted (e.g., an office). The elongate bar may also be attached to a bracket at its two ends to define a space therebetween so that part of each general purpose clip can be inserted into the space. If the space has proper dimensions, the clip is not likely to fall out while the rider is riding.

### CROSS-REFERENCE TO RELATED PATENT APPLICATION

This application is a continuation-in-part of U.S. patent application Ser. No. 12/348,601, filed Jan. 5, 2009 and entitled Accessory Holder for Handlebars, the entire disclosure of which is herein incorporated by reference for all purposes.

### BACKGROUND

Multiple devices exist for securing items on handlebars of bicycles, mopeds, motorcycles and other similar vehicles. Some of these devices, such as those disclosed in U.S. Pat. No. 6,315,182, are capable only of securing items having a particular shape or complimentary configuration. Others, such as those described in U.S. Pat. No. 4,981,243, utilize complimentary portions of adhesive material, such as Velcro, to secure an item to a device. All patents and patent applications referenced herein are incorporated by reference for all purposes.

Additionally, many portable accessories such as cellular telephones, pagers, portable music players (e.g., iPod®), global position systems, pocket computers, walkie-talkies and the like include various forms of general-purpose clips for securing the accessories to various objects. Many of these general-purpose clips are similarly sized because they are designed to be secured to objects of similar size, including belts and arm straps.

### SUMMARY

An accessory-holding assembly is provided for holding portable accessories such as cellular telephones, pagers and portable music devices to a set of handlebars. The assembly includes an elongate member such as a bar or strap that is sized to receive two or more general-purpose clips often associated with portable accessories. The elongate bar may be part of an accessory holder that can be removed, with the accessories still attached, from one or more clamps that are secured to the handlebars. This allows the rider to remove a plurality of portable accessories from the handlebars in a single action so that the rider can carry the entire accessory holder, including the accessories, into an area where bicycles are not permitted (e.g., an office). The elongate bar may also be attached to a bracket at its two ends to define a space therebetween so that part of each general purpose clip can be inserted into the space. If the space has proper dimensions, the clip is not likely to fall out while the rider is riding.

### BRIEF DESCRIPTION OF THE DRAWINGS

FIG. 1 is a view of one embodiment of an accessory-holding assembly including an accessory holder that is removed from associated handlebar clamps.

FIG. 2 is a view of the accessory-holding assembly of FIG. 1, including an accessory holder shown secured to associated handlebar clamps, which in turn are secured to handlebars (shown in phantom).

FIG. 3 is a view of another embodiment of an accessory-holding assembly, similar to the ones shown in FIGS. 1 and 2 except that the clamps are arranged so that the receiving members are above, instead of below, the handlebars.

FIG. 4 depicts an alternative embodiment of an accessory-holding assembly where the pins are integrally formed on the handlebars and the receiving members, which define apertures to receive the pins, are part of the accessory holder.

FIG. 5 depicts an alternative embodiment of an accessory-holding assembly where apertures are defined in the handlebars and the accessory holder includes pins sized to be inserted into the apertures.

FIG. 6 depicts an alternative embodiment where the pin includes a spring-loaded member for securing the pin in the aperture.

FIG. 7 depicts an example cup holder that may be attached to the accessory-holding assembly.

FIG. 8 depicts an alternative embodiment of an accessory-holding assembly where the accessory holder is not removable from the clamps and the elongate member is a nylon strap tautly attached to a bracket.

FIG. 9 depicts a side cutout view of the embodiment of FIG. 8 showing the space between the nylon strap and the bracket.

FIG. 10 is a view of an embodiment of an accessory-holding assembly including an accessory holder that is provided with a releasable locking mechanism.

FIG. 11 is a view of the embodiment of FIG. 8 showing the accessory holder positioned above the clamps prior to mounting thereon.

FIG. 12 is an enlarged view, taken from the side of FIG. 11, with portions cut-away, showing the accessory holder mounted on the clamps prior to the locking mechanism being locked.

FIG. 13 is a view similar to that of FIG. 12 showing the locking mechanism in its locked position.

### DETAILED DESCRIPTION

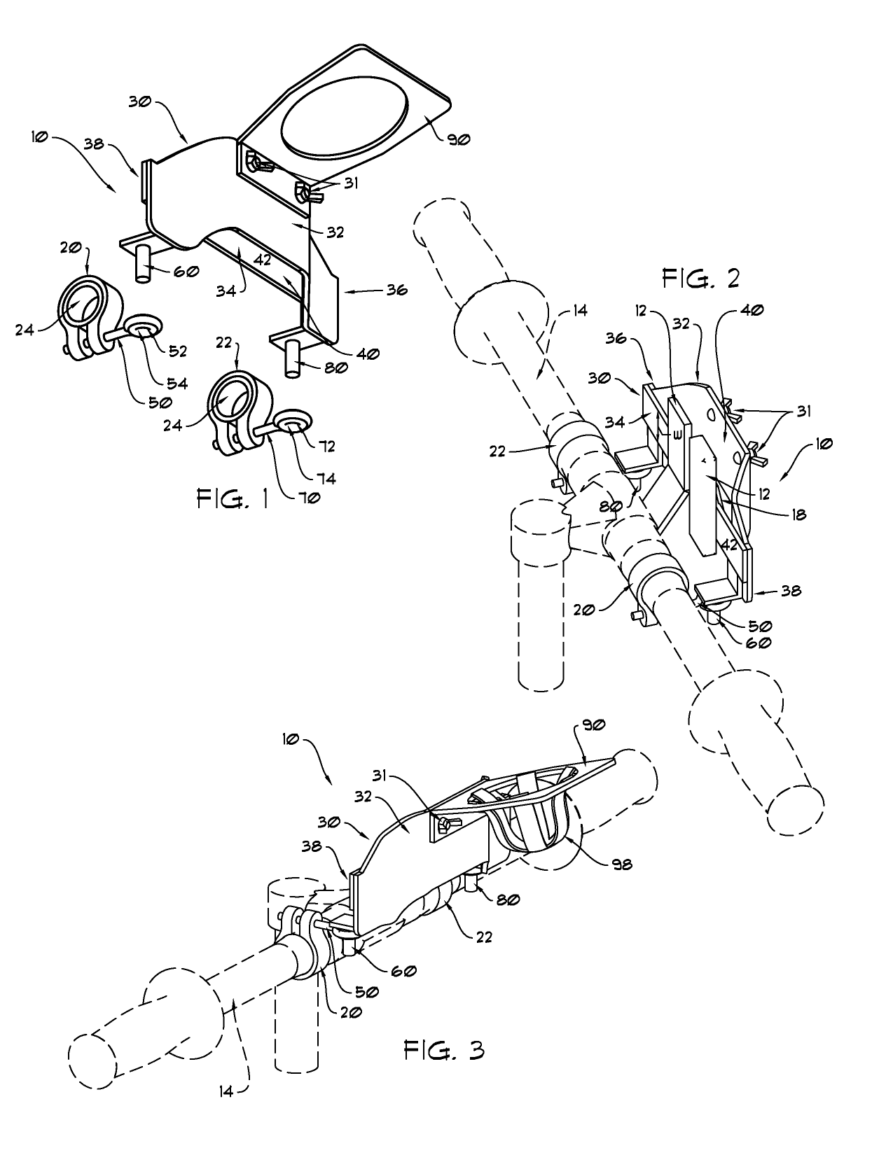

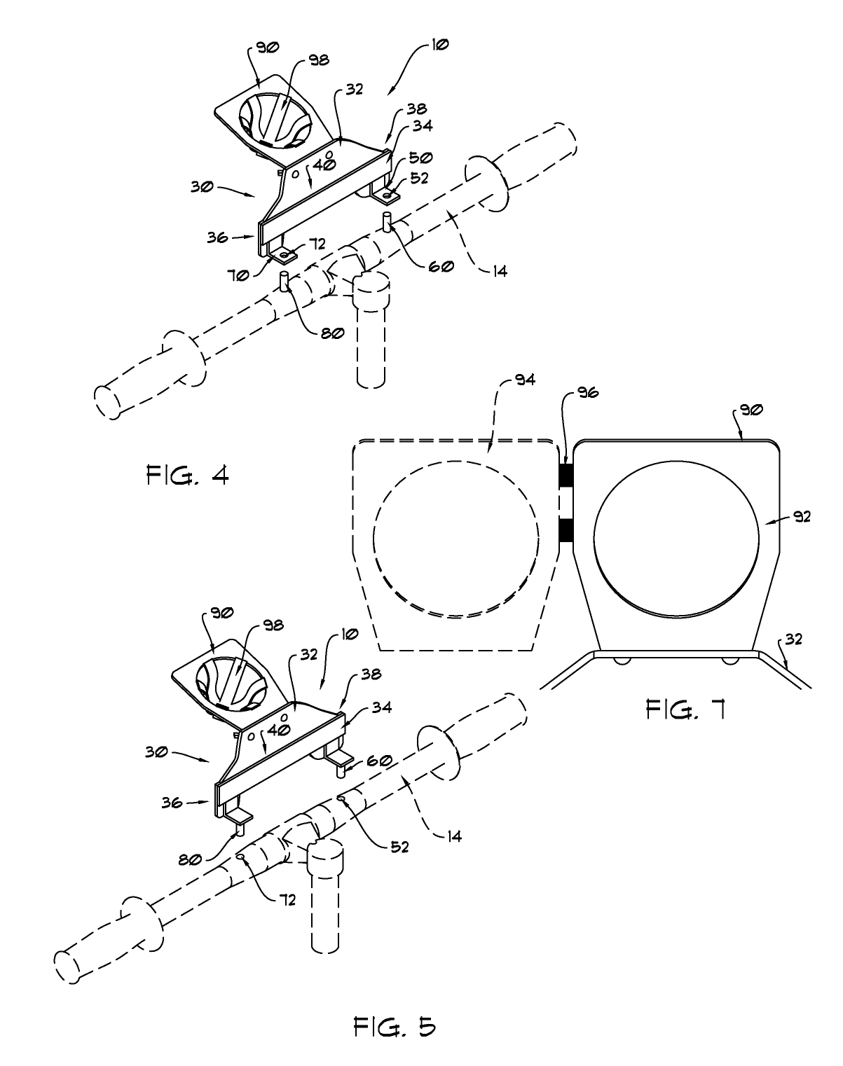

Referring now to FIGS. 1-3, an accessory-holding assembly 10 is provided for securing items such as accessory 12 to a set of handlebars 14 of a bicycle (not shown) using connecting devices such as a clip 18. Although repeated reference to a bicycle will be made herein, it should be understood that accessory-holding assembly 10 may be used with any vehicle having handlebars, including motorcycles, mopeds, scooters and the like.

Accessory-holding assembly 10 may be mounted to handlebars 14 using any number of suitable devices, such as one or more clamps. In the embodiments shown in the drawings, accessory-holding assembly 10 includes a first clamp 20 and a second clamp 22 for mounting accessory holding assembly 10 to handlebars 14. First clamp 20 and second clamp 22 each include a shim 24 for secure retention of the clamps on handlebars 14 so that the clamps will not rotate about or move laterally along the length of handlebars 14.

First and second clamps may be secured at various positions on handlebars 14. For example, second clamp 22 may be adapted to be secured to handlebars 14 at a position spaced from first clamp 20. Securing the clamps at positions spaced from one another, as well as at various positions relative to handlebars 14, allows for accessory-holding assembly 10 to be mounted on a bicycle or other vehicle without interfering with centrally-mounted headlights or other equipment.

Accessory-holding assembly 10 may include an accessory holder 30 for securing accessories such as accessory 12 to handlebars 14. Accessory holder 30 may include a bracket 32 and an elongate member 34 attached to bracket 32 at a first end 36 and a second end 38 so that a portion of elongate member 34 in between the first and second ends is spaced from bracket 32, defining a space 40 between the two.

Elongate member 34 may be sized to receive two or more general-purpose clips associated with two or more portable accessories such as accessory 12. In some embodiments, elongate member 34 may have a length of between about 10 cm and about 25 cm, and thus may be capable of holding several portable accessories in a row. In other embodiments, elongate member 34 may have a length of between about 5 cm and about 10 cm, and thus may be capable of holding two or perhaps three portable accessories. Elongate member 34 may have other dimensions similar to a typical belt. For example, in some embodiments, elongate bar 34 is between about 2 cm and about 4 cm wide (indicated by arrow W in FIG. 2) and between about 2 mm and about 5 mm thick.

In some embodiments, elongate member 34 is rigid and includes one or both of plastic and metal. A surface 42 of elongate member 34 may be slide resistant to prevent accessories such as accessory 12 from shifting during movement. To be slide resistant, elongate member 34 may be at least partially made of and/or include slide-resistant material (e.g., rubber, urethane) on its surface 42. In other embodiments, such as those depicted in FIGS. 8 and 9, elongate member 34 is a nylon strap 46.

In some embodiments, accessory holder 30 may be removable from the one or more clamps (20, 22) that are secured to handlebars 14. This allows a rider to remove a plurality of portable accessories from handlebars 14 in a single movement. The rider then can carry the entire accessory holder, including the accessories, into an area where bicycles are not permitted (e.g., an office building).

One or more pins and corresponding apertures may be provided so that accessory holder 30 is removably attachable to handlebars 14. For example, a first receiving member 50 defining a first aperture 52 may be mounted on or integrally formed with either first clamp 20 or somewhere on accessory holder 30 (e.g., on bracket 32 or elongate member 34). A corresponding first pin 60 may be mounted on or integrally formed with the other of first clamp 20 and accessory holder 30. “Corresponding” is used herein to indicate that first pin 60 is sized to fit within first aperture 52.

In the exemplary embodiments depicted in the drawings, a second receiving member 70 defining a second aperture 72 is mounted on or integrally formed with either second clamp 22 or somewhere on accessory holder 30 (e.g., on bracket 32 or elongate member 34). Likewise, a second pin 80 is mounted on or integrally formed with the other of second clamp 22 and accessory holder 30. Similar to first pin 60 and first aperture 52, second pin 80 may be sized to fit within second aperture 72.

Pins and/or apertures may also be integrally formed on handlebars 14. For example, FIG. 4 depicts an embodiment where first pin 60 and second pin 80 are integrally formed on handlebars 14. First receiving member 50 and second receiving member 70 are formed as part of accessory holder 30, and define first aperture 52 and second aperture 72, respectively. In another embodiment shown in FIG. 5, first aperture 52 and second aperture 72 are integrally formed on handlebars 14. First pin 60 and second pin 80 are formed as part of accessory holder 30.

Various mechanisms may be employed in order to securely retain the pins into the apertures of the receiving members. For example, FIG. 6 depicts an embodiment where first pin 60 includes a hollow interior 62 with an opening. A spring-loaded member 64 may be nominally positioned to extend at least partially out from hollow interior 62 through the opening. In this configuration, the portion of spring-loaded member 64 that is biased out of the opening with a spring 66 prevents movement of first pin 60 in the direction indicated by the arrow A. Thus, first pin 60 is secured in first aperture 52 of receiving member 50 while a rider rides the bicycle. A rider may exert force on spring-loaded member 64 in the direction indicated by the arrow B (and against spring 66) to move spring-loaded member 64 into hollow interior 62, thus allowing free movement of first pin 60 in the direction indicated by the arrow A.

Additionally or alternatively, first aperture 52 of first receiving member and/or second aperture 72 of second receiving member 70 may be lined with slide-resistant material, such as rubber or urethane, configured to frictionally retain the pins in the apertures. Likewise, first pin 60 and/or second pin 80 may contain or be coated with slide-resistant material. In either case, the slide resistant material increases the resistance between the surfaces of the pins and the inner surfaces of the apertures, decreasing the likelihood that the pins will accidentally slide out of the apertures.

Other mechanisms for securing pins into apertures may be employed. For example, first pin 60 may be provided with threads, and first aperture 52 may have complimentary threading, so that accessory holder 30 may be screwed onto the handlebars.

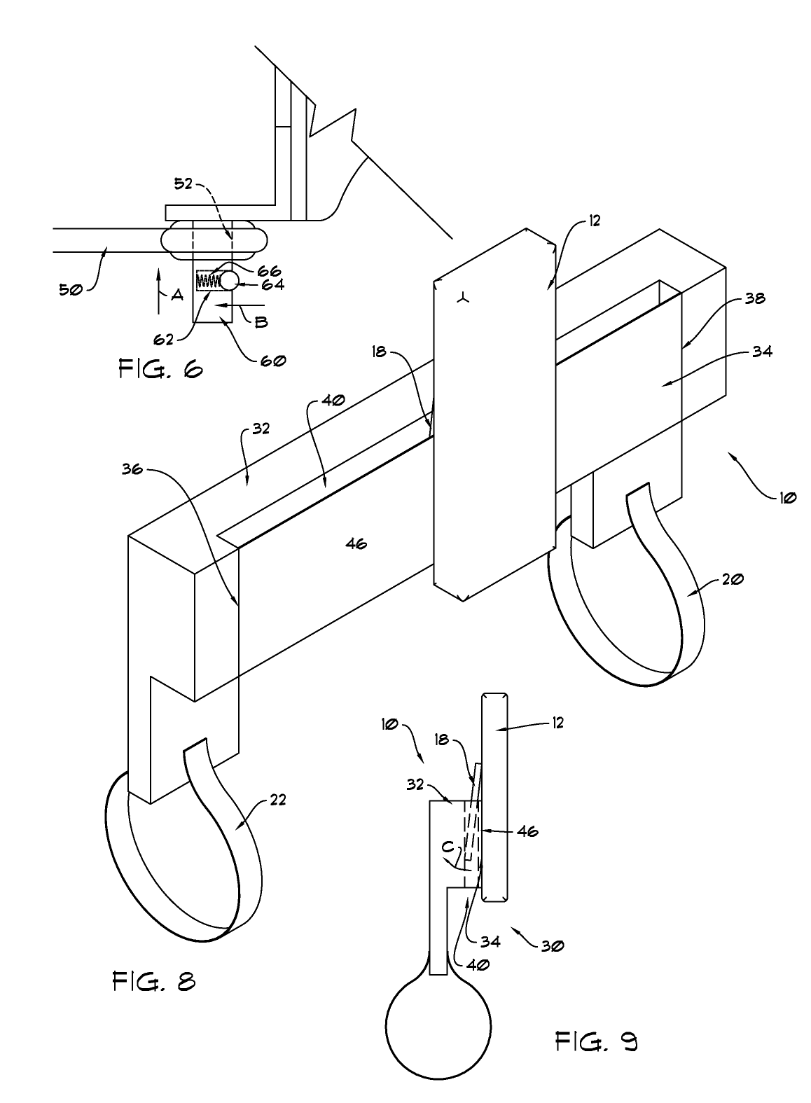

In embodiments such as the ones depicted in FIGS. 1-3, first clamp 20 and second clamp 22 may be secured at various positions relative to handlebars 14. For example, in FIG. 2, the clamps are secured to handlebars 14 so that first receiving member 50 and second receiving member 70 are below handlebars 14. In contrast, the clamps of the embodiment of FIG. 3 are secured to handlebars 14 so that the receiving members are above handlebars 14. The configuration shown in FIG. 3 results in accessory holder 30 being positioned well above handlebars 14, allowing for placement of a headlight or other similar equipment on the center of handlebars 14.

Some embodiments include additional components for holding specific items on handlebars 14. For example, in the embodiments shown in FIGS. 1, 3-5 and 7, a cup holder 90 is mounted to bracket 32 using one or more screws 31 engaged with one or more screw holes. As seen in FIG. 7, cup holder 90 may include a first hoop 92 and a second hoop 94 connected with a hinge 96. One of the first and second hoops may be rotatable between a position where it is concentric with and on top of the other of the first and second hoops and a second position wherein it is adjacent to the other of the two hoops (shown in phantom in FIG. 7). With a hoop in the second position, the rider may carry more than one beverage on handlebars 14. In some embodiments, such as those depicted in FIGS. 3-5, cup holder 90 includes a basket 98, which allows the rider to carry beverages that do not have a tapered shape, such as a can of soda.

Another embodiment is depicted in FIGS. 8 and 9. In this embodiment, elongate member 34 is a nylon strap 46 tautly secured to bracket 32 at its first end 36 and second end 38. Although in this example, accessory holder 30 is not shown being removable from first clamp 20 and second clamp 22, it should be understand that some embodiments include both an accessory holder 30 that is removable from the clamps and a nylon strap 46.

Referring to FIG. 9, elongate member 34 (nylon strap 46 in FIGS. 8 and 9) and bracket 32 are spaced-apart in between first end 36 and second end 38 of elongate member 34 so that a space 40 is formed therebetween. In some embodiments, space 40 is between about 0.5 cm and about 3 cm wide. This range was chosen carefully. It provides enough room for the insertion of a portion of a clip 18 into space 40, while not providing enough room for the inserted portion of clip 18 to rotate in the direction indicated by the arrow C when jarred by movement of the bicycle. This is particularly important in embodiments where elongate member 34 is not thick enough alone to adequately support an accessory clip 18, such as embodiments where elongate member 34 is a nylon strap 46.

### Accessory Holder with Releasable Locking Mechanism

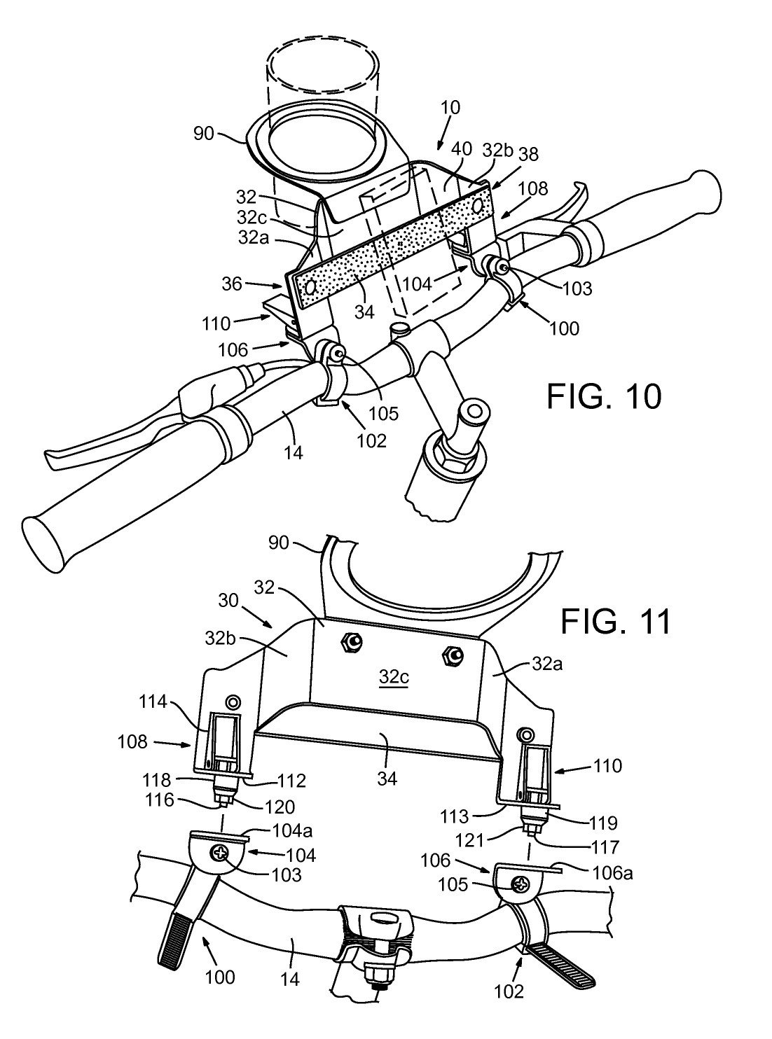

Another embodiment of a handlebar-mounted accessory holder assembly is shown in FIGS. 10-13. In this embodiment, several important structural features are provided which enable the accessory holder to be quickly and securely mounted and locked to the handlebars and yet be quickly released and detached therefrom. These features further enable secure positioning and retention of the accessory holder, regardless if whether the handlebar clamps are positioned on a bent or curved portion. For example, handlebars come in a variety of shapes and configurations, as original equipment from the manufacturer or as an add-on from a supplier in the after-market. It is common for handlebars to have preformed bends or curves, sometimes for function, other times for appearance, sometimes for both, as opposed to simply being a straight cylindrical bar or rod. This means that the accessory holder must be mounted on clamps which may encircle the handlebars and be adjustable to ensure that the accessory holder is mounted generally parallel to the ground. This latter feature is accomplished by specially-configured retaining members mounted on the handlebar clamps which can be selectively oriented to receive mounting members provided on the accessory holder.

FIGS. 10-13 illustrate an embodiment with a novel handlebar clamp construction and a quick-release locking mechanism for detachably mounting the accessory holder to the handlebar clamps, all of which will be described. FIG. 10 is a view of accessory-holding assembly 10 from the perspective of a rider, and shows accessory holder 30, including bracket 32, formed with opposed, first and second ends 32a and 32b, respectively, offset from a central portion 32c interposed therebetween. An elongate member 34 is attached to bracket 32 at first and second sides or ends, generally indicated at 36 and 38, respectively. A portion of the elongate member is spaced from the bracket, thereby defining an open area or space 40 between the two. A cup holder is shown at 90, and the entire assembly is releasably mounted on spaced-apart, first and second clamps, 100 and 102, respectively, each of which is detachably mounted on handlebars 14.

First and second receiving members, generally indicated at 104 and 106 are connected to the first and second clamps, respectively, and each is operable for positioning to a preselected position relative to its associated clamp. The accessory holder further includes spaced-apart, releasable first and second locking mechanisms indicated at 108 and 110, respectively, each of which is selectively operable for releasably locking the accessory holder to first and second clamps, 100 and 102, respectively, as will be described.

Attention is now directed to FIGS. 11-13, and first to FIG. 11, which is a view taken from in front of the handlebars, and shows the accessory holder detached from first clamp 100 and second clamp 102. The locking mechanisms are in their released positions, and accessory holder 30 is positioned above the first and second clamps, and aligned with first and second receiving members, 104 and 106, respectively. The receiving members may be operable for positioning, as by rotation, for example, around the axes defined by fasteners 103 and 105, respectively, to a preselected position relative to their associated clamp, to ensure that the accessory holder can be properly secured to the clamps and oriented substantially parallel to the ground. As shown in FIG. 11, bracket 32 may be provided with opposed first and second mounting members 112 and 113 which may be arranged to engage first and second receiving members 104 and 106, respectively. Each of the first and second mounting members has substantially planar upper and lower surfaces.

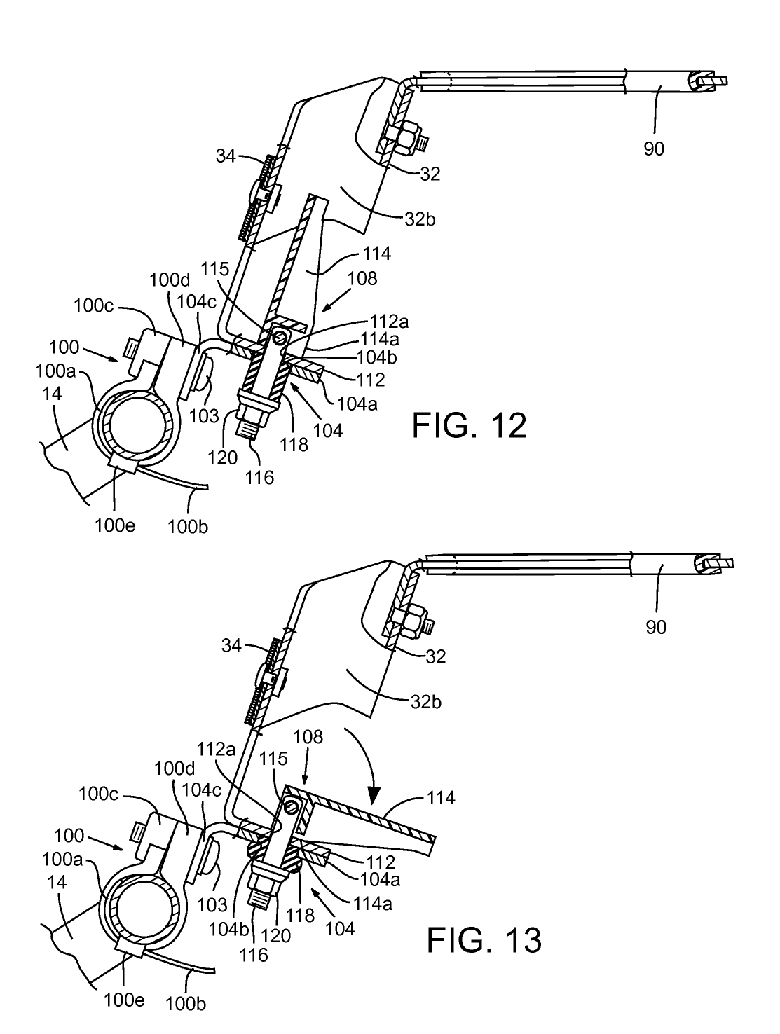

FIGS. 12 and 13 are enlarged side views, with portions broken away, illustrating the construction of various components, and how accessory holder 30 may be mounted on the handlebars, and then secured into a stable position by the releasable locking mechanisms. Only one of the locking mechanisms, its associated receiving member and mounting member will be described, the construction of the opposite locking mechanism and its associated mounts, etc. understood to be the same. As shown in FIG. 12, first clamp 100 may be formed from either a single or two-piece, elongate strap having ends 100a and 100b, and ears 100c and 100d. The strap is initially wrapped around the handlebars at a desired location, and fastener 103, which may be threaded, secures the ears, and also mounts first receiving member 104.

When initially positioned on the handlebars, the fastener is not fully tightened, and ends 100a and 100b are inserted through retainer 100e, for adjustment and wrap-around tightening later (a liner may also be included). As shown, first receiving member 104 may include a plate 104a provided with a substantially planar upper surface and an aperture 104b, and another plate 104c, also is provided with an aperture for receiving fastener 103. The fastener may then extend through the ears, and threadably engage them, for tightening, after first receiving member 104 has been oriented to a preselected position relative to first clamp 100, in a manner to be described later.

Still viewing FIG. 12, it can be seen that first locking mechanism 108 is in its released position, but accessory holder 30 has been moved downwardly, from the position shown in FIG. 11, so that first mounting member 112 of bracket 32 has engages plate 104a of first receiving member 104. Mounting member 112 is provided with an aperture 112a for receiving a movable pin or rod, and as shown, locking mechanism 108, with portions broken away for illustration, is in its first, unlocked position, with an associated locking lever 114 positioned upright. The locking lever may include a cam surface 114a, and is pivotally connected at 115 to a rod 116, which in turn may extend through a cylindrical element 118 of resilient, or compressible material, where a fastening or adjusting nut 120 or the like retains the assembly as a unit.

Aperture 104b is dimensioned to receive therethrough cylindrical element 118, which encircles rod 116. The compressible material is essentially uncompressed as shown in FIG. 12, but when locking lever 114 is rotated clockwise, represented by the arrow in FIG. 13, the cam action of the locking mechanism operates to displace rod 116 upwardly, thereby compressing the material of cylinder 118. Once the locking lever has been rotated to its over-center position, accessory holder 30 is securely yet releasably locked, and cylinder 118 is compressed, ensuring a snug fit, yet providing a degree of resiliency or shock absorbing action to the assembly as a whole.

### Mounting the Accessory Holder to the Releasable Locking Mechanism

Mounting of the accessory holder provided with the releasable locking mechanisms is a relatively straight forward procedure, and requires only a minimal number of readily performable installation steps. The description will proceed here focusing initially on FIG. 12, again directed only to one of the clamps, the first clamp, and its associated mounting components, the other clamp and its components being essentially the same. Initially, it will be presumed that first clamp 100 has been loosened with fastener 103 being removed, so that the clamp, with the straps in place, may be mounted to encircle the handlebars, and the second strap is mounted the same way. The fasteners, such as those at 103 and 105 (see FIG. 11) are then inserted, with their respective receiving members, such as those at 104 and 106 mounted as well, but the clamps are not tightened to grip the handlebars just yet. The clamps must be shifted or adjusted, so that the distance between the apertures on the receiving members, such as aperture 104b on receiving member 104, and the corresponding one on receiving member 106 may be equally spaced on opposite sides of the center of the stem of the bicycle, for example. Of course the overall spacing between them must be the same as the distance between the centerlines of the rods 116 and 117.

As mentioned previously, and as shown in FIG. 10, the shape of the handlebars may have a bend or curve, and this may correspond to where the clamps must be located. Because the receiving members can be pivoted, they are operable for rotation to a preselected position relative to their associated clamps, whereby their associated plates, such as indicated at 104a and 106a in FIG. 11 may be positioned substantially parallel to the ground surface. This insures that accessory holder 30 will be mounted parallel to the ground, regardless of the curve or bend of the handlebars. At this point, fasteners 103 and 105 may be tightened, it being assumed that any play has been essentially first taken up by tightening of the straps of the clamps by pulling on their extended ends. It should be noted that in the views of FIGS. 10-13, receiving members 104 and 106 face toward the front of a bicycle, but they could be positioned to face toward the rear if desired, this would just be a matter of their positioning on their respective clamps.

As shown in FIG. 11, the accessory holder may now be downwardly directed toward the clamps, and this is done with the locking mechanisms in their released orientations, that is with the locking levers pivoted upwardly, as shown in FIG. 11. The accessory holder is then directed downwardly, so that rods 116 and 118 and their associated resilient, cylindrical elements such as those shown at 118 and 119 in FIG. 11 are inserted into their corresponding apertures in the receiving members, such as aperture 104b in plate 104a of receiving member 104, as shown in FIG. 12. Now the last step merely requires that the locking levers be rotated to their locked positions, as shown with respect to locking lever 114 in FIG. 13.

It is believed that the disclosure set forth above encompasses multiple distinct embodiments with independent utility. While each of these embodiments has been disclosed in its preferred form, the specific embodiments thereof as disclosed and illustrated herein are not to be considered in a limiting sense as numerous variations are possible. The subject matter of the disclosure includes all novel and non-obvious combinations and sub-combinations of the various elements, features, functions and/or properties disclosed herein. Similarly, where the disclosure recites “a” or “a first” element or the equivalent thereof, such disclosure should be understood to include incorporation of one or more such elements, neither requiring nor excluding two or more such elements.

Various combinations and sub-combinations of features, functions, elements, and/or properties may be claimed in a related application. Such new claims, whether they are directed to a different invention or directed to the same invention, whether different, broader, narrower or equal in scope to any original claims, are also regarded as included within the subject matter of the present disclosure.

What is claimed is:

1. An accessory-holding assembly comprising:
a first clamp adapted to be secured to handlebars; and
an accessory holder adjacent the first clamp and including:
a bracket having opposed, first and second ends offset from a central portion; and
an elongate member mounted on the bracket at the first and second ends of the elongate member so that the central portion of the elongate member in between the first and second ends is spaced from the bracket, the elongate member being sized to receive two or more general-purpose clips associated with two or more portable accessories.

2. The accessory-holding assembly of claim 1, further comprising:
a first receiving member mounted on one of the first clamp and the accessory holder and defining a first aperture; and
a first pin mounted on the other of the first clamp and the accessory holder, the first pin being sized to fit into the first aperture;
wherein the accessory holder is removably attachable to the first clamp by inserting the first pin into the first aperture.

3. The accessory-holding assembly of claim 2, further comprising:
a second clamp adapted to be secured to the handlebars at a position spaced from the first clamp by a first distance;
a second receiving member mounted on one of the second clamp and the removable accessory holder and defining a second aperture; and
a second pin mounted on the other of the second clamp and the removable accessory holder, the second pin being sized to fit into the second aperture;
wherein the accessory holder is removably attachable to the second clamp by inserting the second pin into the second aperture, and when the accessory holder is attached to the first and second clamps, the first pin is spaced from the second pin by a distance approximately equal to the first distance.

4. The accessory-holding assembly of claim 1, wherein the elongate member is a nylon strap tautly attached to the bracket at the first and second ends.

5. The accessory-holding assembly of claim 1, wherein the elongate member is rigid and is includes at least one of metal and plastic.

6. The accessory-holding assembly of claim 1, wherein a surface of the elongate member is slide-resistant.

7. The accessory-holding assembly of claim 1, wherein the elongate member includes slide-resistant material on its surface.

8. The accessory-holding assembly of claim 1, wherein the elongate member is between about 2 cm and about 4 cm wide.

9. The accessory-holding assembly of claim 1, wherein the elongate member is spaced from the bracket at a distance of between about 0.5 cm and about 3 cm.

10. The accessory-holding assembly of claim 1, wherein the elongate member is between about 2 mm and about 4 mm thick.

11. The accessory-holding assembly of claim 1, further comprising a cup holder mounted to the bracket, the cup holder including two hoops connected to each another with a hinge, wherein one of the two hoops is rotatable between a position where it is concentric with and on top of the other of the two hoops and a position wherein it is adjacent to and not concentric with the other of the two hoops.

12. The accessory-holding assembly of claim 2, wherein the first aperture is lined with a material configured to frictionally retain the first pin in the first aperture.

13. The accessory-holding assembly of claim 12, wherein the material includes at least one of rubber and urethane.

14. The accessory-holding assembly of claim 2, wherein the first pin includes a hollow interior with an opening and a spring-loaded member movable from a nominal position where the spring-loaded member at least partially extends out from the hollow interior through the opening and an active position where the spring-loaded member is substantially contained within the hollow interior.

15. An accessory-holding assembly adapted to be secured to handlebars, comprising:
an accessory holder including:
a bracket having opposed, first and second ends offset from a central portion; and
an elongate member mounted on the bracket at the first and second ends of the elongate member so that the central portion of the elongate member in between the first and second ends is spaced from the bracket at a distance of about 0.5 cm to about 3 cm, the elongate member being sized to receive two or more general-purpose clips associated with two or more portable accessories; and
first and second clamps attached to the accessory holder at positions spaced apart by a first distance and adapted to secure the accessory holder to the handlebars.

16. The accessory-holding assembly of claim 15, further comprising:
a first receiving member mounted on one of the first clamp and the accessory holder and defining a first aperture;
a first pin mounted on the other of the first clamp and the accessory holder, the first pin being sized to fit into the first aperture;
a second receiving member mounted on one of the second clamp and the accessory holder and defining a second aperture; and
a second pin mounted on the other of the second clamp and the accessory holder, the second pin being sized to fit into the second aperture;
wherein the accessory holder is removably attachable to the first and second clamps by inserting the first pin into the first aperture and inserting the second pin into the second aperture, and when the removable accessory holder is attached to the first and second clamps, the first pin is spaced from the second pin by a distance approximately equal to the first distance.

17. A method of securing portable accessories to handlebars of a vehicle, comprising:
attaching a removable accessory holder configured to receive two or more general-purpose clips associated with two or more portable accessories to the handlebars by inserting a first pin mounted on one of the handlebars and the removable accessory holder into a first aperture defined by a first receiving member mounted on the other of the handlebars and the removable accessory holder; and
securing a portable accessory to the removable accessory holder using the portable accessory's general-purpose clip.

18. The method of claim 17, wherein attaching the removable accessory holder further comprises:
inserting a second pin mounted on one of the handlebars and the removable accessory holder into a second aperture defined by a second receiving member mounted on the other of the handlebars and the removable accessory holder.

19. The method of claim 17, further comprising removing the removable accessory holder while the portable accessory is still secured to the portable accessory holder by removing the first pin from the first aperture.

20. The method of claim 19, further comprising the step of, prior to removing the removable accessory holder, manipulating a spring-loaded member from a nominal position where the spring-loaded member at least partially extends out from a hollow interior of the first pin through an opening to an active position where the spring-loaded member is substantially contained within the hollow interior of the first pin.

21. An accessory-holding assembly for mounting on handlebars comprising:
a first clamp for detachable mounting on the handlebars;
a first receiving member connected to the first clamp and operable for rotation to a preselected position relative to the first clamp;
a fastener operable for enabling the first receiving member to be rotated to the preselected position and for releasably securing the first receiving member to the first clamp;
an accessory holder including a bracket and an elongate member mounted on the bracket at first and second ends of the elongate member so that a portion of the elongate member in between the first and second ends is spaced from the bracket, the elongate member being sized to receive two or more general-purpose clips associated with two or more portable accessories;
a first mounting member on the bracket for engaging the first receiving member; and
a releasable locking mechanism selectively operable for locking the first mounting member to the first receiving member.

22. The accessory holding assembly of claim 21 wherein the first receiving member includes an aperture, and wherein the first mounting member also includes an aperture, alignable with the aperture on the first receiving member.

23. The accessory-holding assembly of claim 22 wherein the locking mechanism includes a rod extendable into the apertures of the first receiving member and the first mounting member.

24. The accessory-holding assembly of claim 23 wherein the locking mechanism includes a lever selectively operable for actuating the rod.

25. The accessory-holding assembly of claim 24 wherein the lever is pivotally connected to the rod and is selectively operable for displacing the rod relative to the apertures of the first receiving member and the first mounting member.

26. The accessory-holding assembly of claim 25, wherein a resilient, compressible element receives the rod, and wherein the compressible element is dimensioned to fit in the aperture of the first receiving member.

27. The accessory holding assembly of claim 26 wherein the lever is operable as a cam to compress the compressible element when the lever is moved into the locking position.

28. The accessory holding assembly of claim 21 wherein the fastener for enabling the first receiving member to be rotated is positioned beneath the first mounting member.

29. The accessory-holding assembly of claim 28 wherein the first receiving member and the first mounting member both are configured with substantially planar surfaces for engaging each other.

30. The accessory-holding assembly of claim 29 wherein the planar surface of the first receiving member may be selectively positioned so that it is substantially parallel to the ground.
